(19) United States
(12) Patent Application Publication
(10) Pub. No.: US 2025/0325945 A1
(43) Pub. Date: Oct. 23, 2025

(54) ADSORPTIVE MEMBRANES FOR RECOVERY OF LITHIUM AND SOLAR-DRIVEN RECYCLING OF WATER FROM GEOTHERMAL BRINES

(71) Applicant: University of Kentucky Research Foundation, Lexington, KY (US)

(72) Inventors: Mostafa Khodakarami, Lexington, KY (US); Rick Honaker, Nicholasville, KY (US)

(21) Appl. No.: 19/182,166

(22) Filed: Apr. 17, 2025

Related U.S. Application Data
(60) Provisional application No. 63/635,806, filed on Apr. 18, 2024.

(51) Int. Cl. B01D 69/02; B01D 67/00; B01D 69/14; B01D 71/02; B01D 71/08; C02F 1/44; C02F 101/20; C02F 103/08

(52) U.S. Cl. CPC B01D 69/02; B01D 67/00931; B01D 69/148; B01D 71/0221; B01D 71/02232; B01D 71/08; C02F 1/44; B01D 2311/12; B01D 2311/2626; B01D 2323/36; B01D 2323/38; B01D 2325/026; C02F 2101/20; C02F 2103/08

(57) ABSTRACT

Adsorptive membranes with sponge-like structures for direct recovery of lithium from geothermal brines and recycling of water from geothermal evaporation ponds are disclosed. The membrane surfaces are functionalized with task-specific chemicals capable of selective separation of lithium through host-guest complexation mechanism. The sponge-like structure provides high surface area resulting in an enhanced lithium adsorption capacity. The technology disclosed here aims to reduce the time required for lithium enrichment by evaporative concentration of geothermal brines and address the water loss problem thereof through enhanced solar-driven recycling of water.

### RELATED APPLICATIONS

This is a utility patent application which claims the benefit of U.S. Provisional Patent Application Ser. No. 63/635,806, filed Apr. 18, 2024, which is incorporated herein by reference in its entirety.

### TECHNICAL FIELD

This invention relates to advancement of functional membranes for selective recovery of critical elements. More particularly, this invention relates to design and application of ultralight membranes functionalized with task-specific chemicals for the selective recovery of lithium from geothermal brines.

### BACKGROUND

Lithium is a relatively rare element identified by the U.S. government as a critical mineral for renewable energy technologies. The importance of lithium has increased greatly due to its key role in rechargeable batteries and energy storage applications in electric vehicles.

Although the US is currently producing only ˜1% of global lithium production, the US has enough economically recoverable lithium resources to meet the growing demand, according to the US Geological Survey reports. Aside from hard rock sources such as the Thacker Pass mine in Nevada, brines are accounting for the major share of the lithium sources in the US.

The dominant method for recovery of lithium from brines is evaporative concentration followed by further refining using various methods such as precipitation, ion exchange, and solvent extraction. In evaporative concentration, brine is distributed in a series of hydraulicly connected evaporation ponds and remains for a period of months (1-2 years) for solar evaporation until the lithium concentration in brine is increased to an optimal target value (up to 6%). Although the use of evaporation ponds for lithium concentration is a time- and water-intensive process, it is the dominant method used for the production of lithium from currently established brine resources. It is essential to develop technologies to reduce the environmental footprints of evaporative concentration facilities and for direct recovery of lithium from geothermal brine sources.

### SUMMARY

This document relates to an efficient technology based on adsorptive membranes capable of lithium recovery from geothermal brines. Another object is to fabricate a sponge-like structure functionalized with task-specific chemicals for separation of lithium ions from other metal ions such as sodium, potassium, calcium, and magnesium through a selective host-guest complexation mechanism. Still another object is to address adverse environmental footprints of evaporative concentration of geothermal brines through enhanced solar evaporation mechanism.

Toward this end, a new and improved adsorptive membrane for lithium recovery is provided. The adsorptive membrane comprises, consists of or consists essentially of a three-dimensional polymeric platform having pores functionalized with crown ether derivatives adapted to selectively complex with lithium. The membrane is ultralight with a density lower than water.

In at least some of the many possible embodiments, the crown ether derivatives are covalently or non-covalently grafted onto the surface of the three-dimensional ultralight polymeric platform, wherein the crown ether derivatives are selected from aza-, oxa-, thia-crown ethers, or combination thereof.

In some embodiments, the crown ether derivatives comprise nanoparticles functionalized with crown ether derivatives.

The crown ether derivatives may include aromatic substituents or bulky donor atoms selected from phenyl-based groups (e.g., 2,6-diisopropylphenyl) and branched alky groups (e.g., tert-butyl group), polycyclic compounds (e.g., dibenzo-functionalized crown ethers), and bulky donor atom based on oxygen (e.g., phenoxy), sulfur (e.g., thiophenyl), and nitrogen (e.g., N-tert-butylamine) to enhance lithium selectivity.

In at least some embodiments, the three-dimensional ultralight polymeric platform is functionalized with a polysaccharide to provide functional sites for grafting the crown ether derivatives to the three-dimensional ultralight polymeric platform. The polysaccharide used to functionalize the platform may be selected from a group of plant-based, animal-based, and bacterial polysaccharides. More specifically, the polysaccharide may be selected from a group consisting of (a) chitosan, (b) a derivative of chitosan, (c) cellulose, (d) a derivative of cellulose, (e) a bacterial polysaccharide such as xanthan, gellan and curdlan and (f) combinations thereof. In some embodiments, the polysaccharide includes monomers selected from a group consisting of 3,6-Anhydro α-D-Galactopyranosyl, α-D-Galactopyranosyluronic acid, 3-D-Mannopyranosyluronic acid, 3-D-Mannopyranosyl, α-L-Rhamnopyranosyl, 3-D-Xylopyranosyl, and α-L-Arabinofuranosyl and combinations thereof.

In some embodiments, the adsorptive membrane further includes a photothermal agent. The photothermal agent may be selected from conjugated polymers including polydopamine, polypyrrole, polyaniline, polythiophene, and combinations thereof.

The three-dimensional ultralight polymeric platform may be made from a polymer selected from a group consisting of polyurethane, polydimethylsiloxane, poly(vinyl chloride), polyacrylonitrile, polyethersulfone, natural polymers including polysaccharides and natural polyols, and mixtures thereof.

The nanoparticles may be selected from a group of materials consisting of carbonaceous nanoparticles, clay-based nanoparticles, metallic nanoparticles, silicates and mixtures thereof. The clay-based nanoparticles may consist of halloysite, nanotubes, kaolinite, bentonite and combinations thereof. The silicates may be zeolite.

In some embodiments, the metallic nanoparticles consist of transition metals including metal nanoparticles based on transition metals such as dichalcogenides of molybdenum and tungsten, nickel coatings (Ni—NiO composites), and titanium nitride, in the form of unmodified nanostructures or modified by grafting crown ether derivatives and conjugated polymers such as polydopamine, polypyrrole, polyaniline, polythiophene, and combinations thereof. The inorganic nanoparticles may be functionalized with conjugated polymers including polydopamine, polypyrrole, polyaniline, polythiophene, and combinations thereof.

In at least some embodiments, a surface of the three-dimensional polymeric platform comprises a temperature-responsive polymer layer derived from N-isopropylacrylamide, enabling switchable wettability for adaptation with environment and weather condition.

In accordance with an additional aspect, a new and improved method is provided for selective separation of lithium ions from other metal ions. That method comprises complexing the lithium ions in an adsorptive membrane of the type described in this document. In at least some embodiments, the method includes incorporating the adsorptive membrane with a photothermal surface and carrying out a recovery process under solar illumination to simultaneously enhance evaporation and lithium adsorption.

In the following description, there is shown and described several different embodiments of a new and improved adsorptive membrane for lithium recovery and a related method for selective separation of lithium ions from other metal ions using that membrane. As it should be realized, the membrane and method are capable of other, different embodiments and their several details are capable of modification in various, obvious aspects all without departing from the membrane and method as set forth and described in the following claims. Accordingly, the drawings and descriptions should be regarded as illustrative in nature and not as restrictive.

### BRIEF DESCRIPTION OF THE DRAWING FIGURES

The accompanying drawing figures incorporated herein and forming a part of the specification, illustrate certain aspects of the adsorptive membrane for lithium recovery and together with the description serve to explain certain principles thereof. A person of ordinary skill in the art will readily recognize from the following discussion that alternative embodiments of the illustrated structures and methods may be employed without departing from the principles described below.

FIG. 1 is a schematic illustration of polyol precursor candidate for membrane fabrication.

FIG. 2 is a schematic illustration of organo-modification of clays via ion exchange with amine-based and cations and increase in interlayer spacing.

FIG. 3 is a schematic illustration of carbon nanotubes functionalization with 3-aminopropyltriethoxysilane to act as heterogeneous nucleation sites.

FIG. 4 is a schematic illustration of polyol grafting on cellulose acetate.

FIG. 5 is a schematic illustration of the path for synthesis of crown ethers with heteroatoms via cyclization of bis-epoxides.

FIG. 6 is a schematic illustration of the procedure for fabrication of carboxymethyl chitosan/carbon nanotube/polyurethane membrane platform.

FIG. 7 is a schematic illustration of the strategy for fabrication of sponges with thermo-responsive switchable wettability.

FIG. 8 is a schematic illustration of fabrication route for polyurethane sponge functionalized with graphene oxide functionalized with 4-aminobenzo-12-crown-4 ether.

FIG. 9 is a scanning electron microscopy image of polyurethane sponge functionalized with graphene oxide functionalized with 4-aminobenzo-12-crown-4 ether.

FIG. 10 is an illustration of adsorption/selectivity performance of polyurethane sponge functionalized with graphene oxide functionalized with 4-aminobenzo-12-crown-4 ether.

FIG. 11 is a schematic illustration of fabrication route for photothermal crown ether-functionalized chitosan membrane platform.

FIG. 12 is an illustration of adsorption/selectivity performance of photothermal crown ether-functionalized chitosan membrane platform.

FIG. 13 is an illustration of water evaporation performance of polyurethane sponge functionalized with graphene oxide functionalized with 4-aminobenzo-12-crown-4 ether.

FIG. 14 is an illustration of water evaporation performance photothermal crown ether-functionalized chitosan membrane platform.

Reference will now be made in detail to the present preferred embodiments of the apparatus and method.

### DETAILED DESCRIPTION

Adsorptive membranes are provided with high surface area and functional sponge-like structures (i.e., 3-dimensional platforms with hierarchical porous structure) for selective recovery of lithium from geothermal evaporation ponds as well as direct recovery of lithium from brine before reinjecting it into the ground in geothermal power generation facilities. The membranes comprise hierarchically structured porous materials having rich and diverse architecture with surface area >1 m²/g and distributions of pore sizes in multiple length scales (micro, meso, and macro scales), which help to control the water flux, fouling issues, and overall efficiency of the adsorptive membranes. The membranes can freely float on water and may have densities in the range of 0.008-0.9 g/cm³.

The membranes may be broadly described as including a polymer-based platform having pores functionalized with crown ether derivatives adapted to complex with the lithium. The crown ether derivatives may be selected from a group of crown ether derivatives consisting of aza-oxa- and thia-crown ethers and combinations thereof. The complexation properties of crown ethers may be tailored by substitution of O, N, and S donor atoms with each other in heterocycles. The side arms attached to the crowns may be aromatic compounds capable of x-x interaction with inorganic substrates such as graphene, or linear hydrocarbons with binding capabilities including hydroxyl, carboxyl, and amines. In other embodiments, the crown ether derivatives may comprise nanoparticles functionalized with the crown ether derivatives.

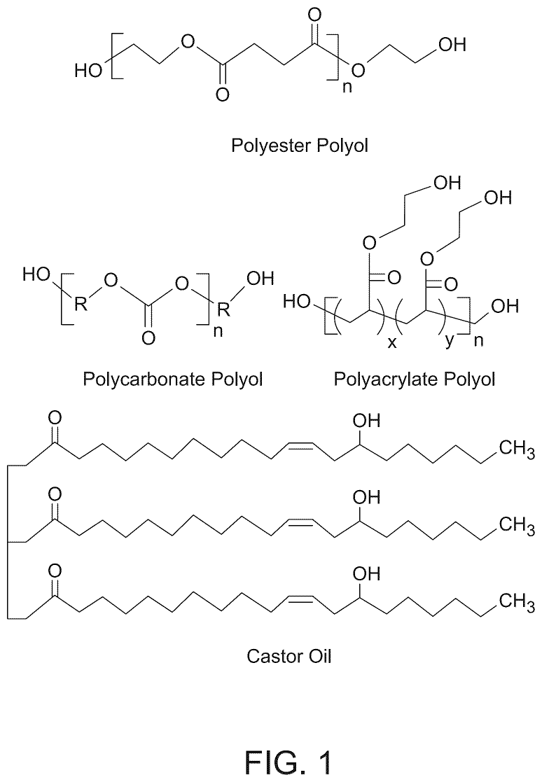

In one embodiment of the invention, polyurethane (PU) is employed as the membrane platform. The formulation of the polyurethane foam membrane may be tailored by selecting various types of polyols, including but not limited to polyether polyols, polyester polyols, polycarbonate polyols, polyacrylate polyols, and natural oil-based polyols (FIG. 1). Suitable diisocyanates and catalysts, including amine-based and metal-based compounds, may also be selected to regulate the reaction kinetics and final properties of the membrane. Surfactants, particularly silicone-based surfactants, may be incorporated to control foam cell structure and stability, while additional additives such as physical or chemical blowing agents, fillers, crosslinking agents, and plasticizers, may be used to modify the pore size distribution, cell density, and overall morphology of the resulting membrane.

Catalysts are essential for controlling the isocyanate-hydroxyl(polymerization) and isocyanate-water (blowing) reactions. Base-driven catalysts, such as tertiary amines including triethylenediamine, N,N-dimethylcyclohexylamine, N,N-dimethylaminoethanol, bis(2-dimethylaminoethyl) ether, N-methylmorpholine, and N-ethylmorpholine may be used. Alternatively, nucleophile-driven catalysts such as organometallic compounds, including dibutyltin dilaurate, stannous octoate, bismuth neodecanoate, bismuth 2-ethylhexanoate, zinc octoate, and zinc neodecanoate may be employed. When physical blowing agents such as hydrofluorocarbons, pentane, or carbon dioxide are used, increased catalyst loading may be necessary to counteract the cooling effect of evaporative heat loss and maintain reaction rates.

Surfactants may be used to enhance precursor miscibility, promote bubble nucleation, and stabilize cell morphology throughout the foaming process. Silicone-based surfactants such as polydimethylsiloxane-polyether block copolymers, polyether-modified siloxanes, and silicone glycol copolymers are preferred. Non-silicone surfactants including polyoxyethylene alkyl ethers, sorbitan esters, alkylphenol ethoxylates, and fluorinated surfactants such as perfluoropolyethers may also be used, depending on the desired application. In certain embodiments, reactive surfactants such as polyether polyols functionalized with surface-active groups or terminally reactive silicone compounds may be chemically incorporated into the polyurethane matrix to provide long-term structural stability.

In one embodiment, inorganic nanoparticles are incorporated into the polyurethane matrix to regulate and enhance structural, thermal, and functional performance. Such nanoparticles may include, but are not limited to, modified and unmodified clay-based fillers (e.g., montmorillonite) and carbon-based nanomaterials (e.g., graphite, carbon nanotubes, graphene, graphene oxide nanoribbons). The influence of such fillers is dependent on their aspect ratio, surface chemistry, and dispersion uniformity. Nanoclays may form intercalated or exfoliated morphologies within the matrix, contributing to improved mechanical integrity, barrier properties, and thermal resistance.

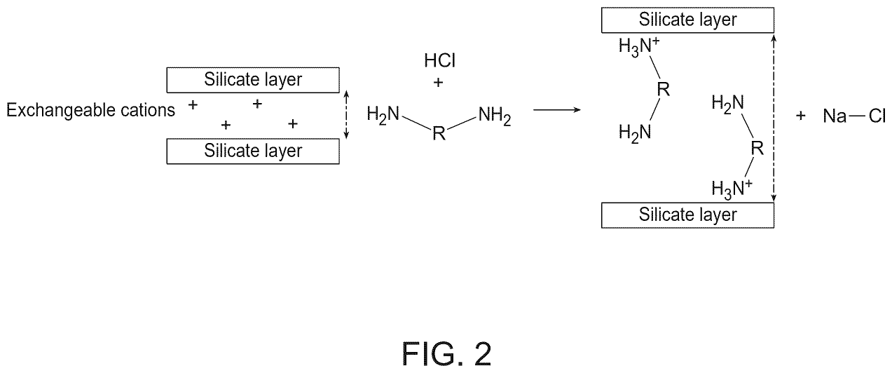

To enhance dispersion, techniques such as ultrasound-assisted mixing, microwave processing, and chemical modification of clay tactoids may be employed. Organo-modification of clays via ion exchange with amine-based and alkylammonium cations (e.g., cetyltrimethylammonium bromide) can increase interlayer spacing and compatibility with the polyurethane matrix (FIG. 2). Organo-modified clays may be used at loadings range of 0.1-2 wt %.

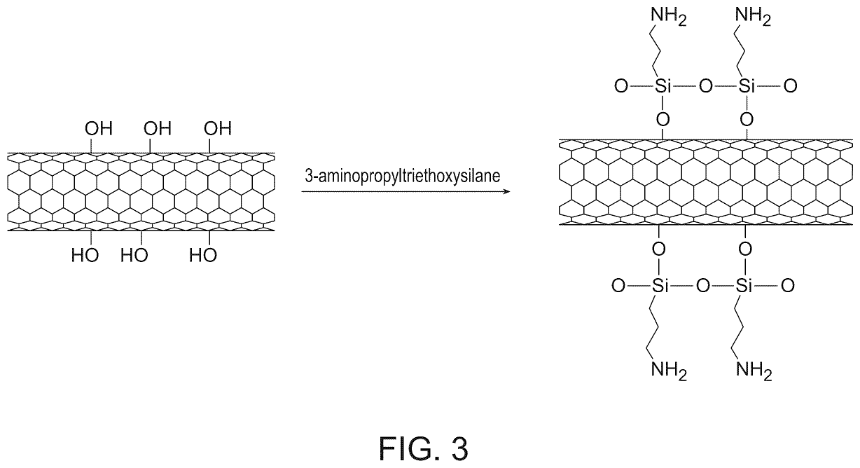

In some embodiments, functionalized nanoclays, such as amine-modified clays, may be introduced into bio-based polyurethane matrices. The presence of NH₂ groups facilitates urea linkage formation with isocyanate, improving interfacial adhesion and matrix reinforcement. Similarly, surface-modified carbon nanotubes, such as hydroxylated carbon nanotubes (CNTs) functionalized with 3-aminopropyltriethoxysilane (FIG. 3), may act as heterogeneous nucleation sites, enhancing foam microstructure and mechanical properties. However, high nanofiller loadings (i.e., >3 wt %) may cause aggregation, disrupt cell morphology, and reduce mechanical performance.

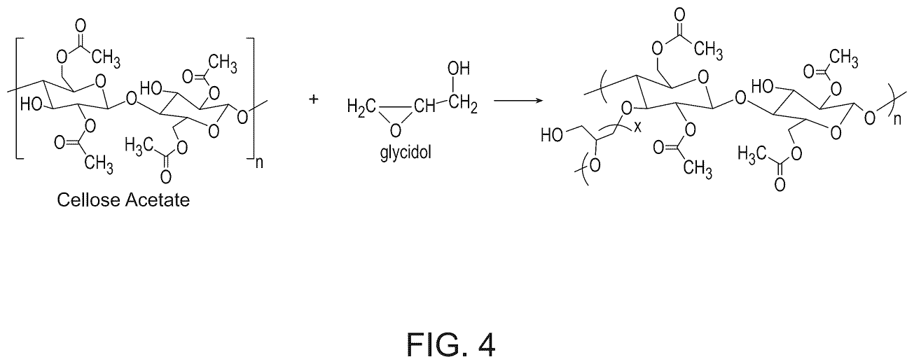

Multicomponent nanocomposites comprising nanoclays, CNTs, and nanofibers (e.g., polyacrylonitrile) may be formulated to further enhance performance, including regulation of pore geometry, tensile strength, and thermal properties. In other embodiments, polyurethane may be blended with hydrophilic cellulose derivatives such as cellulose acetate (CA) to form composite membranes with improved fouling resistance, biocompatibility, and durability. The phase-separated hard and soft segment morphology of the platform can result in enhanced chemical and mechanical resilience (FIG. 4).

In alternative embodiments, synthetic polymers such as polyacrylonitrile (PAN) and polyethersulfone (PES) may be used as the primary foam or membrane-forming matrix. PAN-based membranes may be prepared via nonsolvent induced phase separation and optionally functionalized with tetrazole-containing copolymers to impart hydrophilicity, surface charge, and enhanced ion adsorption capacity. PES may be modified with hydrophilic or charged groups and combined with nanoparticles to mitigate fouling and improve selectivity.

In all embodiments involving alternative polymers, nanocomposite foam membranes may be prepared via in situ polymerization, melt mixing, solution blending, or phase inversion methods. Inorganic nanofillers such as nanoclays, carbon-based nanomaterials, and layered double hydroxides may be dispersed within the polymer matrix to enhance mechanical strength, surface area, and adsorptive capacity.

In at least some embodiments, the polymer-based platform is functionalized with a polysaccharide to provide functional sites for grafting the crown ether derivatives to the polymer-based platform. In some embodiments, the adsorptive membrane includes a photothermal agent. In some embodiments, the photothermal agent is selected from conjugated polymers including polydopamine, polypyrrole, polyaniline, polythipene and combinations thereof.

More specifically, in some embodiments, polyurethane in combination with polysaccharides and inorganic nanoparticles are employed for the construction of the adsorptive membranes. The polysaccharides are built from monosaccharides monomers which function as the building units that can be used for the formulation of “polymers” to regulate hydrophilic-hydrophobic balance. Useful monomers for building the polysaccharides include, but are not necessarily limited to, 3,6-Anhydro α-D-Galactopyranosyl, α-D-Galactopyranosyluronic acid, 3-D-Mannopyranosyluronic acid, 3-D-Mannopyranosyl, α-L-Rhamnopyranosyl, 3-D-Xylopyranosyl, and α-L-Arabinofuranosyl and combinations thereof. Alkyl chains may be introduced into the structure of polysaccharides through a reaction between hydroxyl and/or amino groups of polysaccharides and chemical compounds such as carboxylic acids, aldehydes, esters, and ethers of various length to modify the hydrophilicity of the polysaccharides.

The molecular weight of the polysaccharides can be high or low, ranging from oligomers to polymers, mainly depending on the fabrication method, properties of other constituents, and the final membrane properties required, such as morphology, mechanical properties, wettability, and reactivity. For example, larger molecules are preferred in the coating process, while lower molecular weights can be utilized if polysaccharides are incorporated into the composite matrix via solution blending and grafting on inorganic structures.

The properties of membranes are tailored by small modifications of the formulation, such as tailoring the content of polymerization components including polyol and isocyanate. The hydrophilic properties of the membranes are controlled by substitution of hydroxyl groups of polysaccharides with other moieties having different hydrophobic characters, such as ethers, esters, aldehydes, and alkyl chains. Inorganic nanoparticles are incorporated to enhance the mechanical properties, control membrane morphology, control water sorption and ion adsorption capacities, and render photothermal properties to the membranes.

The surface of the membrane pores is functionalized with crown ether (CE) derivatives, as cyclic chemical compounds consisting of 4-6 membered rings, which can bind certain cations. The ring in crown ether provides a cavity which fits the size of lithium ions. The coordinating atoms in the crown ether ring are well situated to bind with lithium located at the interior of the ring. The crown ether selectivity is mainly controlled by the cavity size of the crown ether as well as the size and charge density of the lithium and other competitor ions. The size of cavities in crown ethers is preferred to be in the range of 0.6-1.3 Å.

In certain embodiments, CEs bearing bulky substituents or mixed donor atoms (O, N, S) are employed to further restrict access of larger ions and improve selectivity toward Lit. CEs incorporating both rigid aromatic moieties (such as dibenzo-functionalized macrocycles) and bulky side groups can provide high selectivity and reversible Li⁺ binding and prevent non-selective sandwich complexation. Bulky side groups might be selected from phenyl-based groups (e.g., 2,6-diisopropylphenyl), branched alky groups (e.g., tert-butyl group), and polycyclic compounds (e.g., dibenzo-functionalized crown ethers).

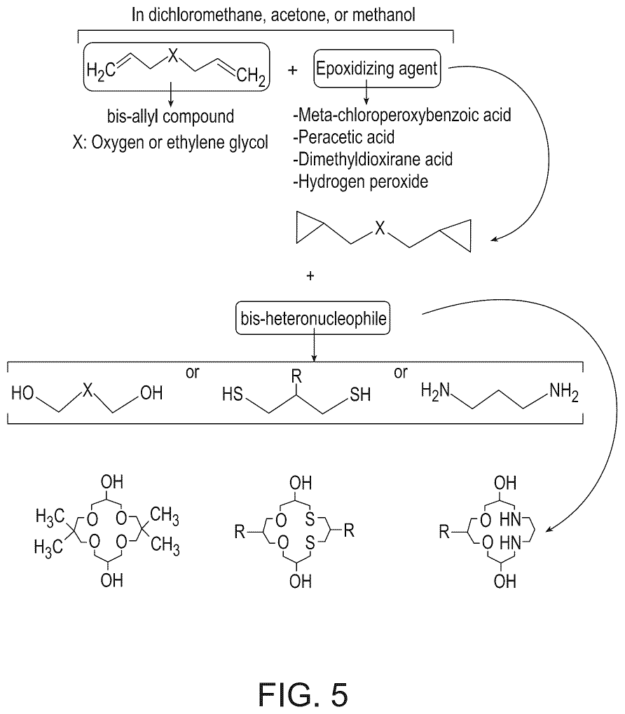

These compounds may be synthesized via cyclization of bis-epoxides. First, bis-epoxide are prepared by epoxidation of the corresponding bis-allyl compounds in the presence of epoxidizing agents such as meta-chloroperoxybenzoic acid, peracetic acid, dimethyldioxirane, or hydrogen peroxide with a catalyst (e.g., tungsten, molybdenum, or titanium-based catalysts such as titanium tetraisopropoxide) in solvents such as dichloromethane, acetone, or methanol (FIG. 5). Then, functionalized crown ethers are prepared by stepwise ring-closing reaction between the bis-epoxides and a bis-heteronucleophile containing two nucleophilic sites, such as —OH, —NH₂, and —SH. These two react through nucleophilic ring-opening of the epoxide groups, eventually forming a macrocyclic ring (FIG. 5).

High dilution might be required to favor intramolecular cyclization over polymerization, and polar aprotic solvents like tetrahydrofuran, dimethylformamide, or dimethyl sulfoxide are used in the presence of a weak base (e.g., sodium hydrogen carbonate, triethylamine) to enhance nucleophilicity without degrading the epoxide.

In some embodiments, surface functionalization of membrane foams is performed by covalent grafting, silanization, or click chemistry, enabling stable presentation of CE binding sites. In additional embodiments, cyclodextrins (e.g., β-cyclodextrin) may be immobilized on the foam or incorporated into the foam matrix, optionally in combination with azobenzene-based guests to construct photoresponsive supramolecular systems for reversible aggregation and disaggregation under light stimulus, providing switchable transport behavior for use in controlled lithium separation.

In other embodiments, nitrogen-containing macrocycles such as azabenzo crown ethers may be used for functionalization. Such macrocycles may be synthesized via alkylation of substituted anilines with 2-chloroethanol in the presence of calcium carbonate, followed by ditosylation and macrocyclization with diols such as 1,2-bis(2′-hydroxyethoxy)benzene. Mixed-donor crown ethers containing nitrogen, oxygen, and sulfur atoms may also be synthesized by condensing ditosylates with dithiols or diols under basic conditions. The hydroxyl-terminated macrocycles may be covalently tethered to the foam surface to form robust lithium-selective adsorptive membranes.

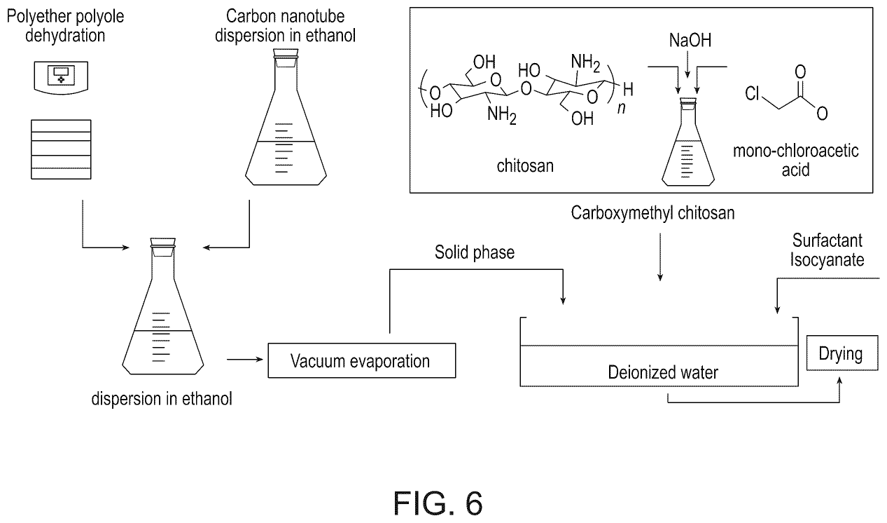

In one embodiment, the polyurethane membranes may be functionalized with polysaccharides and relative derivatives to provide functional sites for grafting and cross linking with crown ether derivatives. The crown ether derivatives may be grafted on the structure of polysaccharides, instead of incorporating them into inorganic nanostructures. The procedure used for grafting 2-hydroxymthyl-12-crown-ether on chitosan is schematically shown in FIG. 6.

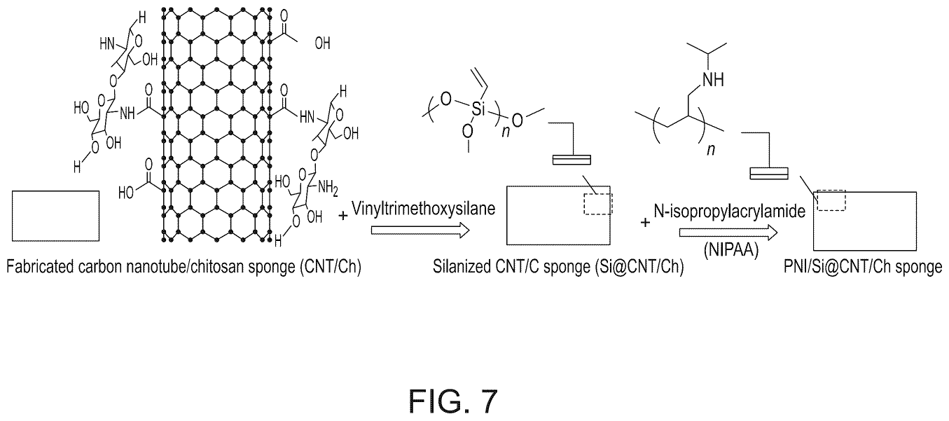

For the top surface of membranes exposed to sunlight, a temperature-responsive sponge with switchable wettability level may be fabricated to regulate the water sorption capacity based on the weather temperature and evaporation rate. In FIG. 7, the strategy to fabricate the temperature-responsive sponge is schematically shown. N-isopropylacrylamide as a temperature-responsive monomer is polymerized with C═C groups of the carbon nanotube/chitosan sponge silanized with vinyltrimethoxysilane. The carbon nanotubes are carboxylated to improve the dispersion properties of carbon nanotubes and thermal conductivity of sponges. Employing conjugated polymers such as polydopamine, polypyrrole, polyaniline, polythiophene, and combinations thereof can improve the light absorption capability of top surface of adsorptive membranes. The enhanced light absorption capacity leads to higher heating rate of the top surface of membrane in contact with brine, resulting in enhanced evaporation rate.

The photothermal properties may be incorporated or enhanced through adding metal nanoparticles based on transition metals including palladium, platinum, silver, and gold nanoparticles, dichalcogenides of molybdenum and tungsten (MoS₂, and WS₂), nickel coatings (Ni—NiO composites), and titanium nitride. Metallic fractions might be used in their unmodified form as nano-particles, cubes, shells, spheres, rods, and sheets. The metal nanostructures may be modified by grafting crown ether derivatives and conjugated polymers such as polydopamine, polypyrrole, polyaniline, polythiophene, and combinations thereof.

### EXPERIMENTAL EXAMPLES

### Example 1: Fabrication and Performance of Graphene Oxide-Crown Ether Functionalized Polyurethane Membrane

In one embodiment, graphene oxide (GO) was first carboxylated by treating with chloroacetic acid and sodium hydroxide. The resulting carboxylated GO was then activated using N-Ethyl-N′-(3-dimethylaminopropyl) carbodiimide (EDC) and further subjected to esterification with N-hydroxy-succinimide (NHS) to yield an intermediate suitable for classical amidation through nucleophilic substitution. This intermediate was subsequently reacted with an aminobenzo crown ether, forming a GO-crown ether composite.

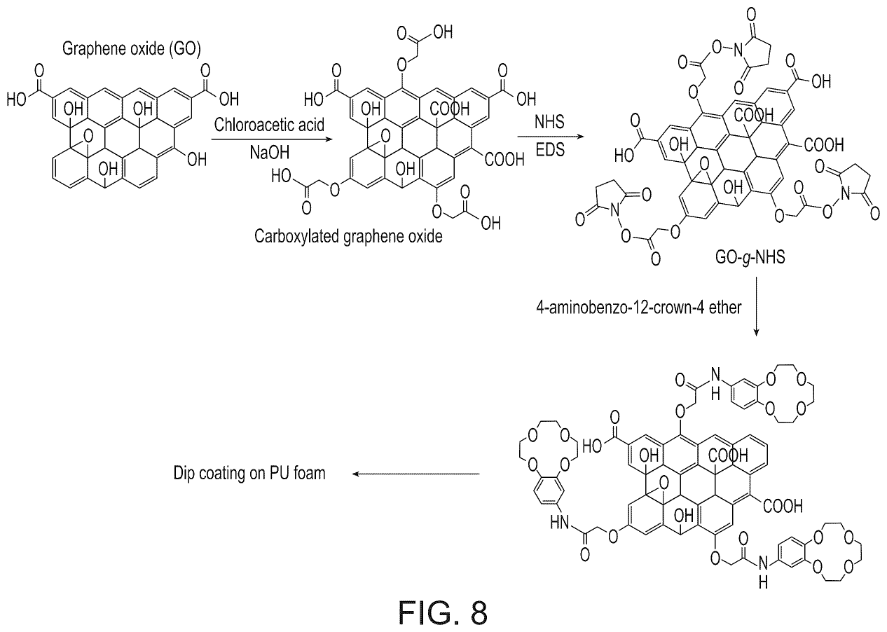

The crown ether-functionalized GO was coated onto a polyurethane sponge substrate via dip coating. The coting of graphene oxide on polyurethane is enhanced through thermal curing and mechanical interlocking mechanism. The use of an aminobenzo crown ether introduced aromatic I-x interactions with the GO surface, potentially influencing the lithium ion complexation mechanism (FIG. 8).

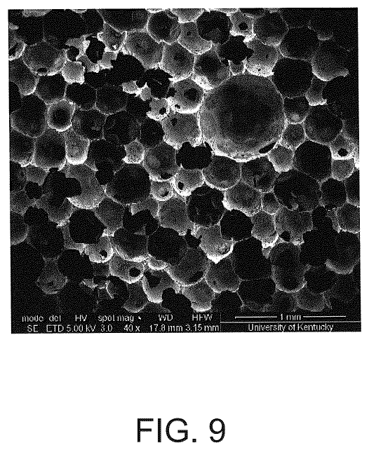

Scanning electron microscopy (SEM) was used to analyze the morphology of the functionalized foam (FIG. 9). The specific surface area of this platform was measured to be approximately 1.7 m²/g.

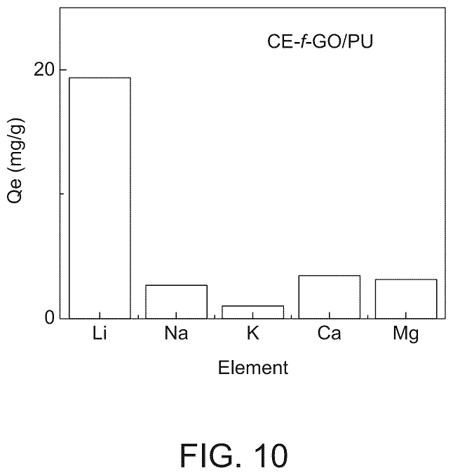

Following lithium ion extraction experiments conducted in simulated brine containing equimolar concentrations of Li⁺, Na⁺, K⁺, Ca²⁺, Mg²⁺ (200 ppm), the graphene oxide-crown ether functionalized polyurethane platform demonstrated selective uptake of lithium ions. After 4 hours of contact at ambient conditions (25° C., pH 7), the lithium adsorption capacity was determined to be ˜19 mg/g, whereas sodium, potassium, calcium, and magnesium adsorption capacities remained below 5 mg/g (FIG. 10).

X-ray photoelectron spectroscopy analysis confirmed the presence of adsorbed lithium on the membrane surface. A distinct Li Is peak was observed at ˜54-56 eV, confirming lithium ion binding. The N 1s and O 1s regions showed chemical shifts corresponding to the interaction between lithium and crown ether donor atoms, indicating successful coordination complex formation.

### Example 2: Fabrication and Performance of Photothermal Crown-ether-Functionalized Chitosan Platform

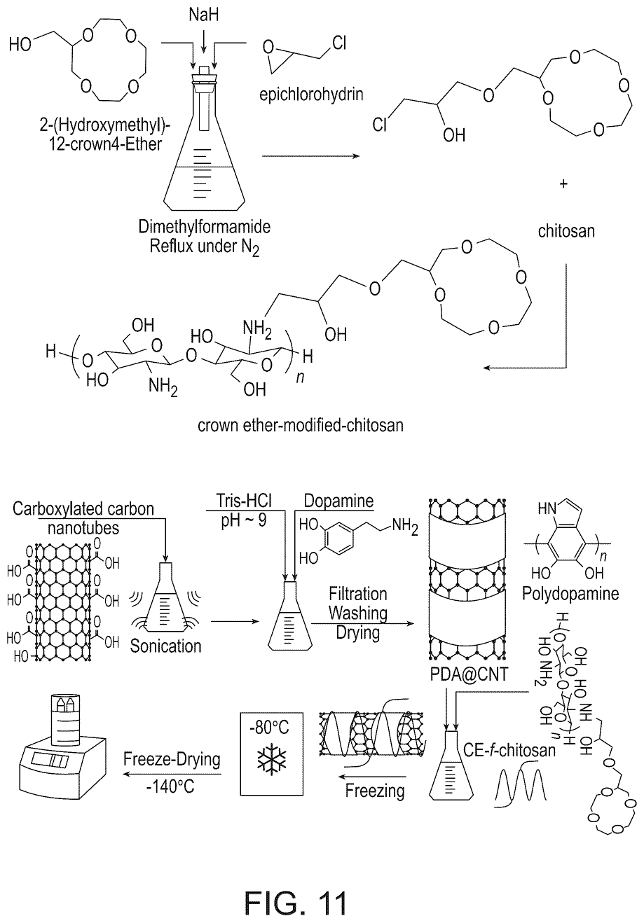

In another embodiment, 2-(Hydroxymethyl)-12-crown-4-ether (2H12C4) was reacted with epichlorohydrin in the presence of sodium hydride (NaH) to activate the crown ether (FIG. 11). The activated intermediate was then reacted with chitosan dissolved in 2 wt % acetic acid to initiate a substitution reaction. Following the reaction, the mixture was subjected to solvent evaporation, and the crude product was washed and purified through multiple rinsing and filtration steps.

To incorporate photothermal properties and investigate solar evaporation efficiency, the chitosan priorly functionalized with crown ether was grafted on carbon nanotubes functionalized with polydopamine. CNTs were first hydroxylated/carboxylated using a mixture of sulfuric acid and nitric acid to introduce hydroxyl and carboxyl groups. Subsequently, dopamine was self-polymerized under alkaline conditions to form polydopamine (PDA), which was grafted onto the oxidized CNTs. The resulting PDA-CNT hybrid was used for grafting crown ether-chitosan, and the resulting gel was frozen at −80° C. for 24 hours, followed by freeze-drying at −140° C. for 48 hours, resulting in a porous photothermal chitosan platform functionalized with crown ether (specific surface area approximately 7.1 m²/g).

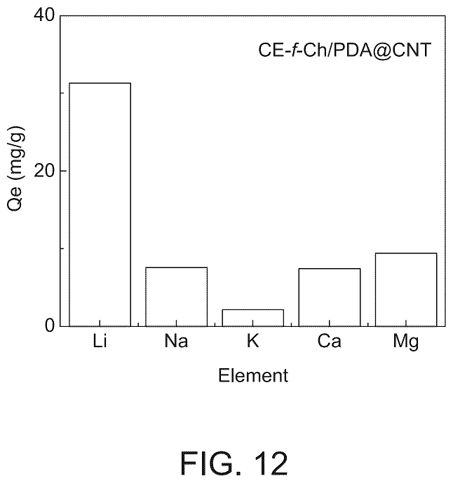

The crown ether-functionalized chitosan aerogel platform exhibited a maximum lithium ion adsorption capacity of 31 mg/g under identical testing conditions (200 ppm Li⁺, 25° C., pH 7, 4 h exposure). The separation factor of Li⁺ relative to other interfering metal ions were all above 1. Particularly, the separation factor of Li⁺ with respect to K⁺ reached ˜20 (FIG. 12).

The pH of the solution plays an important role in the adsorption capacity of chitosan-based platform. As pH increases, the adsorption capacity also increases gradually. The minimum adsorption capacity occurs at pH 2, as the active groups on the surface of chitosan become protonated in acidic environment.

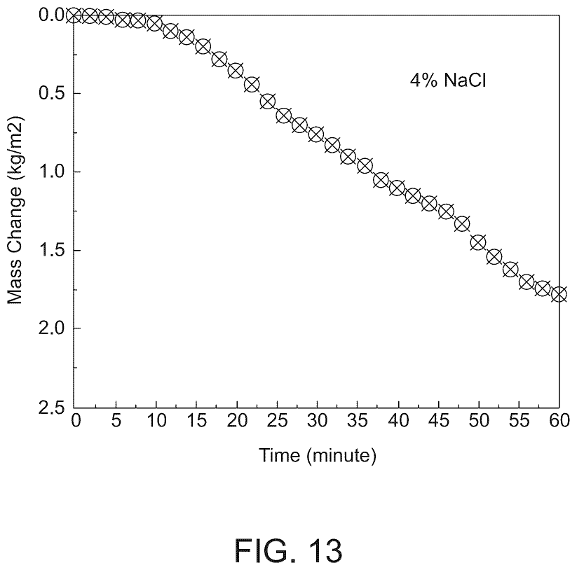

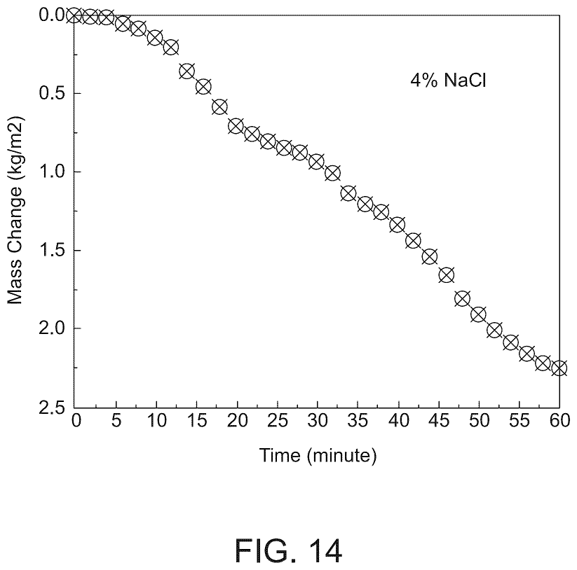

The photothermal performance of the chitosan aerogel modified with CNTs and PDA was evaluated under 1 sun illumination (1000 W/m²). The water evaporation rate was determined to be 2.3 kg/m²·h, higher than the rate observed for graphene oxide-crown ether functionalized polyurethane (1.7 kg/m²·h). The improvement is attributed to enhanced light absorption and localized heating effects due to the PDA coating and the dispersion of CNTs (FIG. 13 and FIG. 14).

Each of the following terms written in singular grammatical form: “a”, “an”, and “the”, as used herein, means “at least one”, or “one or more”. Use of the phrase “One or more” herein does not alter this intended meaning of “a”, “an”, or “the”. Accordingly, the terms “a”, “an”, and “the”, as used herein, may also refer to, and encompass, a plurality of the stated entity or object, unless otherwise specifically defined or stated herein, or, unless the context clearly dictates otherwise. For example, the phrase: “a polymer”, as used herein, may also refer to, and encompass, a plurality of polymers.

Each of the following terms: “includes”, “including”, “has”, “having”, “comprises”, and “comprising”, and, their linguistic/grammatical variants, derivatives, or/and conjugates, as used herein, means “including, but not limited to”, and is to be taken as specifying the stated component(s), feature(s), characteristic(s), parameter(s), integer(s), or step(s), and does not preclude addition of one or more additional component(s), feature(s), characteristic(s), parameter(s), integer(s), step(s), or groups thereof.

The phrase “consisting of”, as used herein, is closed-ended and excludes any element, step, or ingredient not specifically mentioned. The phrase “consisting essentially of”, as used herein, is a semi-closed term indicating that an item is limited to the components specified and those that do not materially affect the basic and novel characteristic(s) of what is specified.

Terms of approximation, such as the terms about, substantially, approximately, etc., as used herein, refers to ±10% of the stated numerical value.

Although the (a) adsorptive membrane and (b) related method for selective separation of lithium ions from other metal ions of this disclosure have been illustratively described and presented by way of specific exemplary embodiments, and examples thereof, it is evident that many alternatives, modifications, or/and variations, thereof, will be apparent to those skilled in the art. Accordingly, it is intended that all such alternatives, modifications, or/and variations, fall within the spirit of, and are encompassed by, the broad scope of the appended claims.

What is claimed:

1. An adsorptive membrane for lithium recovery, comprising:
a three-dimensional polymeric platform having pores functionalized with crown ether derivatives adapted to selectively complex with lithium.

2. The adsorptive membrane of claim 1, wherein the crown ether derivatives are covalently or non-covalently grafted onto the surface of the three-dimensional ultralight polymeric platform, wherein the crown ether derivatives are selected from aza-, oxa-, thia-crown ethers, or combination thereof.

3. The adsorptive membrane of claim 1, wherein the crown ether derivatives comprise nanoparticles functionalized with crown ether derivatives.

4. The membrane of claim 1, wherein the crown ether derivatives include aromatic substituents or bulky donor atoms selected from phenyl-based groups (e.g., 2,6-diisopropylphenyl) and branched alky groups (e.g., tert-butyl group), polycyclic compounds (e.g., dibenzo-functionalized crown ethers), and bulky donor atom based on oxygen (e.g., phenoxy), sulfur (e.g., thiophenyl), and nitrogen (e.g., N-tert-butylamine) to enhance lithium selectivity.

5. The adsorptive membrane of claim 1, wherein the three-dimensional polymeric platform is functionalized with a polysaccharide to provide functional sites for grafting the crown ether derivatives to the three-dimensional ultralight polymeric platform.

6. The adsorptive membrane of claim 1, further including a photothermal agent.

7. The membrane of claim 6, wherein the photothermal agent is selected from conjugated polymers including polydopamine, polypyrrole, polyaniline, polythiophene, and combinations thereof.

8. The adsorptive membrane of claim 1, wherein the three-dimensional polymeric platform is made from a polymer selected from a group consisting of polyurethane, polydimethylsiloxane, poly(vinyl chloride), polyacrylonitrile, polyethersulfone, natural polymers including polysaccharides and natural polyols, and mixtures thereof.

9. The adsorptive membrane of claim 3, wherein the nanoparticles are selected from a group of materials consisting of carbonaceous nanoparticles, clay-based nanoparticles, metallic nanoparticles, silicates and mixtures thereof.

10. The adsorptive membrane of claim 9, wherein the clay-based nanoparticles consist of halloysite nanotubes, kaolinite, bentonite and combinations thereof.

11. The adsorptive membrane of claim 9, wherein the silicates are zeolite.

12. The adsorptive membrane of claim 9, wherein the metallic nanoparticles consist of transition metals including metal nanoparticles based on transition metals such as dichalcogenides of molybdenum and tungsten, nickel coatings (Ni—NiO composites), and titanium nitride, in the form of unmodified nanostructures or modified by grafting crown ether derivatives and conjugated polymers such as polydopamine, polypyrrole, polyaniline, polythiophene, and combinations thereof.

13. The adsorptive membrane of claim 9, wherein the inorganic nanoparticles are functionalized with conjugated polymers including polydopamine, polypyrrole, polyaniline, polythiophene, and combinations thereof.

14. The adsorptive membrane of claim 5, wherein the polysaccharide is selected from a group of plant-based, animal-based, and bacterial polysaccharides.

15. The adsorptive membrane of claim 14, wherein the polysaccharide is selected from a group consisting of (a) chitosan, (b) a derivative of chitosan, (c) cellulose, (d) a derivative of cellulose, (e) a bacterial polysaccharide such as xanthan, gellan and curdlan and (f) combinations thereof.

16. The adsorptive membrane of claim 5, wherein the polysaccharide includes monomers selected from a group consisting of 3,6-Anhydro α-D-Galactopyranosyl, α-D-Galactopyranosyluronic acid, 3-D-Mannopyranosyluronic acid, 3-D-Mannopyranosyl, α-L-Rhamnopyranosyl, 3-D-Xylopyranosyl, and α-L-Arabinofuranosyl and combinations thereof.

17. The adsorptive membrane of claim 1, wherein a surface thereof comprises a temperature-responsive polymer layer derived from N-isopropylacrylamide, enabling switchable wettability for adaptation with environment and weather condition.

18. A method for selective separation of lithium ions from other metal ions, comprising complexing the lithium ions in an adsorptive membrane as set forth in claim 1.

19. The method of claim 18, including incorporating the adsorptive membrane with a photothermal surface and carrying out a recovery process under solar illumination to simultaneously enhance evaporation and lithium adsorption.
